(19) United States
(12) Patent Application Publication
(10) Pub. No.: US 2026/0024531 A1
(43) Pub. Date: Jan. 22, 2026

(54) INFORMATION PROCESSING METHOD, COMPUTER, AND RECORDING MEDIUM

(71) Applicant: Panasonic Automotive Systems Co., Ltd., Kanagawa (JP)

(72) Inventor: Hiroshi YAHATA, Osaka Fu (JP)

(73) Assignee: Panasonic Automotive Systems Co., Ltd., Kanagawa (JP)

(21) Appl. No.: 19/268,593

(22) Filed: Jul. 14, 2025

(30) Foreign Application Priority Data
Jul. 17, 2024 (JP) 2024-114176

(51) Int. Cl. G10L 15/30; G10L 15/22

(52) U.S. Cl. CPC G10L 15/30; G10L 15/22

(57) ABSTRACT

An information processing method is executed by a first computer installed in a vehicle in a human-agent interaction system. The method includes interfacing interaction processing with a user by a first AI agent implemented on a second computer on a network by using a microphone and a speaker provided in the vehicle. The interfacing is performed while being connected to the second computer via a communication device of the vehicle. The method includes recording a first conversation log related to conversation content between the first AI agent and the user in a memory of the first computer. The method includes, when connection to the second computer is disconnected, causing the communication terminal or a second AI agent implemented in the first computer to execute second interaction processing with the user based on the first conversation log.

### CROSS-REFERENCE TO RELATED APPLICATIONS

This application is based upon and claims the benefit of priority from Japanese Patent Application No. 2024-114176, filed on Jul. 17, 2024, the entire contents of which are incorporated herein by reference.

### FIELD

Embodiments described herein relate generally to an information processing method, a computer, and a recording medium.

### BACKGROUND

Conventionally, a service of multiple voice interaction agents is used in a computer provided in a vehicle, such as an in-vehicle device.

For such a service, there is a known technique for calling a voice interaction agent having a function required by a user (for example, JP 2021-117302 A).

In a human-agent interaction system capable of communicate with a user, a voice interaction agent (inference processing of an AI agent) capable of interaction correlated with the user may be implemented on the cloud side, from the viewpoint of the calculation amount. In such a case, an edge side of an in-vehicle computer or the like may serve as a user interface of the AI agent.

In the human-agent interaction system, there is a case where exchange with the called AI agent cannot be performed due to, for example, a network disconnection.

### SUMMARY

An information processing method according to one aspect of the present disclosure is executed by a first computer. The first computer is provided in a vehicle in a human-agent interaction system capable of interacting with a user. The method includes interfacing first interaction processing with the user by a first AI agent implemented on a second computer on a network by using a microphone and a speaker provided in the vehicle. The interfacing is performed while being connected to the second computer via a communication device provided in the vehicle or via a communication terminal capable of communicating with the first computer. The method includes recording a first conversation log related to conversation content between the first AI agent and the user in a memory of the first computer. The method includes, when connection to the second computer is disconnected, causing the communication terminal or a second AI agent implemented in the first computer to execute second interaction processing with the user based on the first conversation log.

### BRIEF DESCRIPTION OF THE DRAWINGS

FIG. 1 is a diagram illustrating an example of an overall configuration of a human-agent interaction system according to an embodiment;

FIG. 2 is a diagram illustrating an example of a hardware configuration of the human-agent interaction system according to the embodiment;

FIG. 3 is a sequence diagram illustrating an example of the exchange by an API between a client (information terminal or vehicle) and a server (cloud) via a wide-area communication network in the human-agent interaction system according to the embodiment;

FIG. 4 is a sequence diagram illustrating an example of a procedure of processing in which a client downloads and uses agent attribute information in the human-agent interaction system according to the embodiment;

FIG. 5 is a diagram illustrating an example of a function configuration of a human-agent interaction system according to the embodiment;

FIG. 6 is a sequence diagram illustrating an example of a procedure of processing in which a network disconnection is detected and a server executing inference processing using an AI model is switched to an edge side in the human-agent interaction system according to the embodiment;

FIG. 7 is a flowchart illustrating an example of a procedure of processing in a case where the client side (UI side) changes the agent in the human-agent interaction system according to the embodiment;

FIG. 8 is a diagram for describing an example of a data structure of a task status notification in the human-agent interaction system according to the embodiment;

FIG. 9 is a flowchart illustrating an example of a procedure of processing in a case where the server side (AI execution side) changes the agent in the human-agent interaction system according to the embodiment;

FIG. 10 is a sequence diagram illustrating an example of a procedure of processing handed over from the vehicle agent to the cloud agent along with the network restoration in the human-agent interaction system according to the embodiment;

FIG. 11 is a diagram illustrating an example of a notification in the human-agent interaction system according to an embodiment; and

FIG. 12 is a flowchart illustrating an example of a procedure of processing of managing a use log of a partner-type agent in the human-agent interaction system according to the embodiment.

### DETAILED DESCRIPTION

Hereinafter, embodiments of an information processing method, a computer, a program, a communication terminal, and a human-agent interaction system according to the present disclosure will be described with reference to the drawings.

In recent years, technology development of an AI agent using a large-scale language model (LLM) has progressed. The AI agent has short term memory (a use log of a user, or part of its content), and can autonomously communicate with an external app or a web service via a network, and start or operate another app or web service. As a result, the AI agent is a computer system that sets or updates a goal via communication with the user by text or voice (instruction content to the AI is also referred to as a prompt), autonomously generates a task group necessary for achieving the goal, and executes information processing of the generated task sequentially autonomously or while communicating with the user, thereby achieving the final goal, or a software program that executes the computer system. AI that can handle information, not only one modal (data format) such as text, for example, but also combination of a plurality of different modalities such as voice and image and can perform input or output information processing is referred to as multi-modal AI.

The AI agent can be added with expertise and characteristics according to a database referred to when performing information processing and an algorithm for task generation. As a result, the AI agent can be implemented as, for example, a highly specialized agent specialized in a specific function. On the other hand, the AI agent can be implemented as a personalized AI agent close to an individual user by learning preference, biometric information, and past action history of the user who communicates with, or accessing a database in which data of such an individual user is accumulated (hereinafter, referred to as user attribute information). The former AI agent may be referred to as a specialized agent, and the latter AI agent may be referred to as a partner-type agent.

It is contemplated that a partner-type agent may function as a particularly effective partner in a mobility space. This is because when the user moves to a place different from the normal range of behavior by a vehicle and experiences a new (or unusual) experience, the partner-type agent can be a suitable navigator that closely follows the personality of the user. The partner-type agent may make, for example, a selection or suggestion reflecting the user's preference when navigating the travel route of the vehicle. Examples of the user's preference include whether the user prefers the shortest route, prefers a road that is easy to drive due to sidewalk separation or the like, and prefers to stop at a tourist spot.

The present inventor has studied a series of user experiences regarding use of a vehicle and use of an AI agent. The first assumption is a scene where an AI agent on which AI inference processing is executed by a server is used from an in-vehicle system of a vehicle via a computer network. In such a case, even if the vehicle enters a place with a poor communication environment and the network becomes unavailable, there is a need to seamlessly continue the exchange with the AI agent. On the other hand, in a case where AI inference processing is executed by the server, how communication with the user and an ongoing task can be appropriately continued when the network is disconnected or unstable has an issue from the viewpoint of customer value and implementation means.

First, the definition of the artificial intelligence agent (AI agent) will be described. The AI agent is software or a mechanism for achieving a predefined goal. The AI agent is designed to autonomously generate and select an action for achieving the goal based on communication with the user, a situation of a surrounding space S of the user, external information acquired via a network regarding interaction with the user, and the like, and execute the action so as to achieve the goal. The communication with the user includes all means that conveys user's emotions, intentions, and thoughts. For example, the communication with the user includes one or more means of an intention expression means via voice information such as a conversation, a pause before utterance, or a tone of voice (voice user interface: VUI), an intention expression means via visual information such as letters and symbols (graphical user interface: GUI), an intention expression means via a physical operation such as a button or a switch (physical user interface: PUI), and an intention expression means by a body motion such as an expression, a line of sight, a posture, or a gesture (natural user interface: NUI). In the present embodiment, the AI agent is also simply referred to as an agent. The agent may be expressed as a unique character in order to smoothly communicate with the user, and in that case, the agent has attribute information of the character. The attribute information of the agent includes, for example, information regarding one or more of appearance, body, clothes, decorations, gesture, expression, voice, personality, taste, habit, knowledge, and experience of the character (record regarding the exchange with the user in the past).

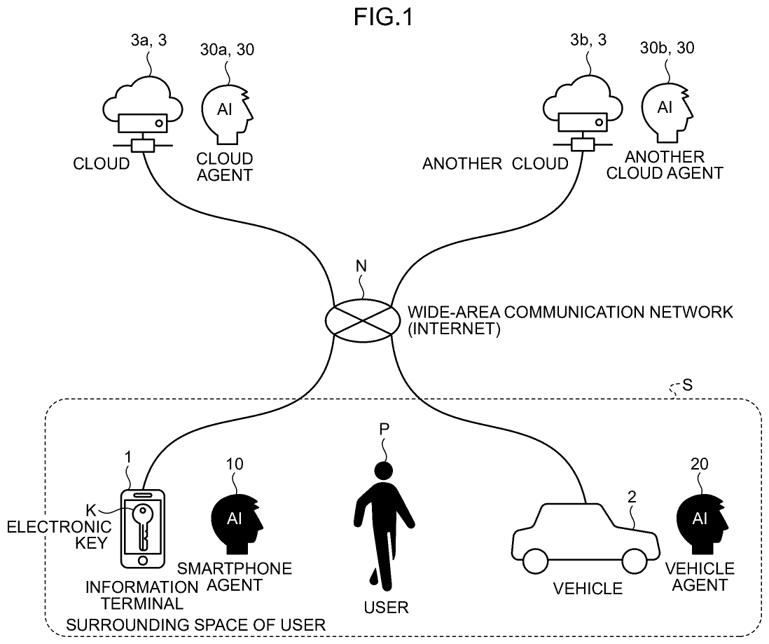

FIG. 1 is a diagram illustrating an example of an overall configuration of a human-agent interaction system according to the embodiment. Note that, in the present disclosure, an agent system that performs the above-described communication with the user is referred to as an “interaction agent” or a “human-agent interaction system”, or simply an “agent”. The human-agent interaction system according to the embodiment is an example of a human-agent interaction system capable of interacting with the user. Note that, in the present disclosure, the communication between the user and the agent system may include not only the interaction but also the other communication described above. In the present disclosure, there is a case where it is described as “interactable” or the like for readability, but these descriptions can be appropriately replaced with “communicable”.

As illustrated in FIG. 1, the human-agent interaction system according to the embodiment includes at least one information terminal 1, at least one vehicle 2, and at least one cloud 3. The information terminal 1, the vehicle 2, and the cloud 3 are communicably connected to each other by a network N. The network N is a wide-area communication network such as the Internet. In addition, the information terminal 1 and the vehicle 2 are communicably connected by peer to peer (P2P) via a network N or near field communication C.

Note that FIG. 1 illustrates a human-agent interaction system including one information terminal 1, one vehicle 2, and two clouds 3, but the number of each can be changed as appropriate. For example, the human-agent interaction system may include zero or two or more information terminals 1. Similarly, the human-agent interaction system may include zero or two or more vehicles 2. Similarly, the human-agent interaction system may include zero, one, or three or more clouds 3.

Information of an electronic key for unlocking and activating the vehicle 2 is recorded in the information terminal 1 of the user.

In the human-agent interaction system according to the embodiment, each agent is implemented in each device of the information terminal 1, the vehicle 2, and the clouds 3a and 3b by recording a pre-trained AI model such as a large-scale language model (LLM) in each device. Moreover, the AI model is used in combination with a framework (software) for operating the AI model, thereby executing exchange (interaction) with a user P of each agent.

The framework inputs information based on the utterance of the user P (or information according to a request) to the AI model. The AI model executes inference for outputting information according to the input information. The framework acquires the information output from the AI model, generates a response to the user based on the acquired information, and presents the generated response to the user P.

The recording of the AI model may mean recording the structure of the AI model (for example, the structure of the neural network) and the trained parameter in the memory of the device. Moreover, training of the AI model may be optimizing or determining (updating) a parameter that defines the AI model according to the purpose of the AI model.

A smartphone agent 10 is an AI agent implemented on the information terminal 1. Specifically, the smartphone agent 10 is software in which an AI model is recorded in the information terminal 1 such as a smartphone and operates by working inference processing using the AI model. The smartphone agent 10 is an agent that operates as a daily partner of the user, and is correlated with the electronic key for using the vehicle 2.

A vehicle agent 20 is an AI agent implemented on at least one computer (in-vehicle system) provided in the vehicle 2. Specifically, the vehicle agent 20 is software that records an AI model in the in-vehicle system of the vehicle 2 and operates by working inference processing using the AI model.

A cloud agent 30a is an AI agent implemented on at least one computer (server) that implements the cloud 3a. In addition, another cloud agent 30b is an AI agent implemented on at least one computer that implements another cloud 3b. Specifically, each cloud agent 30 is an agent that operates in a server-client type. The cloud agent 30 performs inference processing according to the request received on the cloud 3 (server), generates a response, and returns the response to the client. The cloud agent 30 and the smartphone agent 10 are agents that can be used from any terminal (client) used by the user P, and are agents (partner-type agents) that can have the exchange with the user P after deeply understanding the behavior, thoughts, and experience of the user P by performing tasks that occur daily and acting together. The cloud agent 30 according to the embodiment is an example of a first AI agent implemented in a second computer.

Note that the human-agent interaction system according to the embodiment may switch the service provided by the vehicle agent 20 and the like depending on the position of the user. For example, the vehicle agent 20 is an agent that can be used in the in-vehicle system, and is an agent developed mainly for the exchange with the user P on board, such as driving assistance, route guidance, and questions regarding the vehicle 2. The vehicle agent 20 has a feature of changing a response/communication range to a request between a user P who is on board and a user P who is not on board and remotely communicating from a remote place. For example, the risk of attack via the network to the in-vehicle system can be reduced by changing the service or ability that can be provided depending on whether the user P is inside the vehicle or outside the vehicle. For example, in a case where the in-vehicle system of the vehicle 2 on which the vehicle agent 20 is executed directly exchanges video, audio, physical operation (such as screen touch), and the like with the user P, or in a case where the information terminal 1 of the user P is within a predetermined distance from the vehicle 2, it may be determined that the user is in the vehicle. For example, in a case where the in-vehicle system indirectly has the exchange with the user via a network with another computer system such as a smartphone, or in a case where the device serving as the user interface of the user P is not the in-vehicle system of the vehicle 2, it may be determined that the user P is outside the vehicle.

As one specific example, the user P can know the indoor temperature of the vehicle 2 by asking the vehicle agent 20 a question via the network from a place far away from the vehicle 2 using the information terminal 1. However, in this case, the user P cannot activate the air conditioner via the vehicle agent 20 in order to adjust the indoor temperature of the vehicle 2. The user P can activate the air conditioner of the vehicle 2 via the vehicle agent 20 only when the user P is in the vehicle interior or when the in-vehicle system of the vehicle 2 is used as a user interface device that communicates with the user P.

In addition, the smartphone agent 10 and the vehicle agent 20 can operate only by the computer resources and data of the device even in a situation where the Internet is not connected, such as a case where the user P drives the vehicle 2 and moves in an area with a poor radio wave environment. On the other hand, in a case where any agent is connected to the Internet, necessary information is searched and acquired from the Internet and a response is generated.

In addition, the user P who is driving the vehicle 2 communicates with the cloud agent 30 operating on the cloud 3 (server) via video, audio, text information, and the like using the in-vehicle system of the vehicle 2 as a client. In this case, another agent (the vehicle agent 20 or the smartphone agent 10) or a client terminal (or an app executed therein) used by the user may explicitly participate in the exchange between the user P and the cloud agent 30, or the exchange may be monitored without participation or may not be monitored.

Note that the AI agent may be worked by the information terminal 1 implemented by a mobile terminal such as a smartphone. However, it is conceivable that a mobile terminal such as a smartphone does not have high reception performance as compared with the vehicle 2, for example, and connection (network connection) to the network N is likely to be disconnected. Therefore, when the network connection is likely to be disconnected, the in-vehicle system of the vehicle 2 having higher radio wave reception performance may perform the network connection to be connected to the information terminal 1 by tethering so that the information terminal 1 can be less likely to be disconnected from the network. The tethering by the vehicle 2 may be automatically performed in a case where the user P enters an area with low radio field intensity with reference to the radio field intensity map of the carrier in a contract with the user P. In addition, the communication device such as the information terminal 1 brought into the vehicle 2 may be constantly tethered. In addition, in a case where the radio wave reception intensity decreases, a tethering request may be made from the information terminal 1 to the vehicle 2, and the tethering may be started.

The electronic key stored in the information terminal 1 is used for authentication of unlocking and activation of the vehicle 2. The product number of the information terminal 1 and the information on the contracted carrier may be stored in association with the information on the electronic key. At the timing of activating the vehicle 2 using the electronic key of the information terminal 1, notification of the product numbers of these smart phones and information on the contracted carrier may be provided to the vehicle 2 side. In addition, the vehicle 2 may update the radio field intensity map in response to acquisition of the carrier information and store the radio field intensity map in the memory of the vehicle 2.

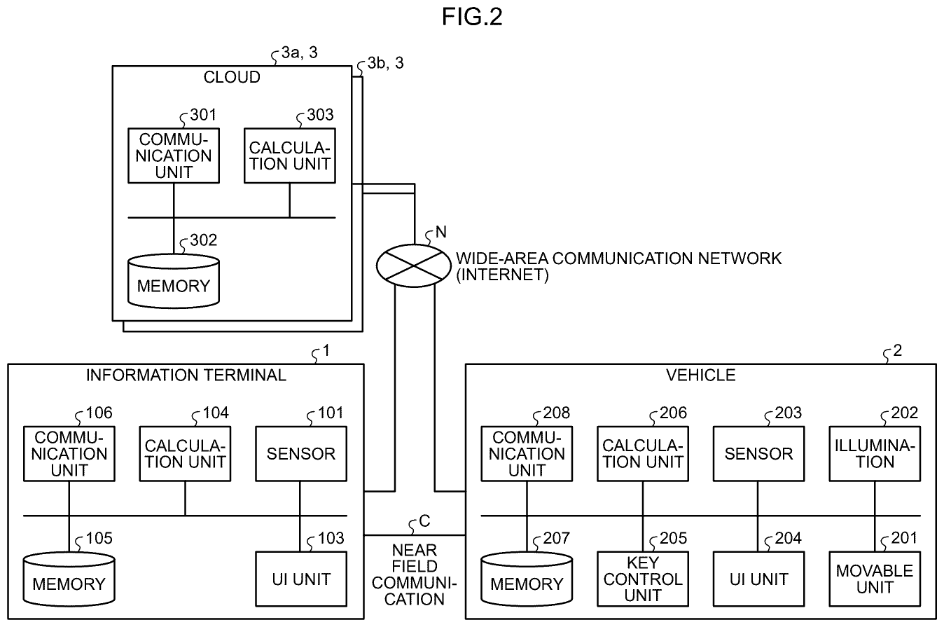

FIG. 2 is a diagram illustrating an example of a hardware configuration of the human-agent interaction system according to the embodiment.

The information terminal 1 includes at least a sensor 101, a UI unit 103, a calculation unit 104, a memory 105, and a communication unit 106.

The sensor 101 acquires at least one of video information, audio information, and a physical quantity of a surrounding environment.

The UI unit 103 receives a button press, a touch operation, or the like from the user. The UI unit 103 includes a display that displays the GUI, and a speaker and a microphone that input and output the VUI.

The calculation unit 104 performs information processing such as various calculations and information drawing performed in the information terminal 1. The calculation unit 104 is an example of a processor for causing the smartphone agent 10 (for example, a partner-type agent) to execute generation processing.

The memory 105 holds data and files used by the calculation unit 104. The memory 105 is an example of a memory that records at least one of access information including an address of an agent to be called (subpoenaed) to the information terminal 1, agent attribute information regarding each agent, and an AI model for executing inference processing on the information terminal 1. In addition, the memory 105 may record a use log of each agent by the user. In addition, the memory 105 may record a use log related to at least one agent available to the user. Moreover, the memory 105 may manage (record) information regarding at least one electronic key available to the user.

The communication unit 106 communicates with another computer on the communication network via the network N.

When an application that executes an AI agent is provided in the information terminal 1, a program and necessary data are recorded in the memory 105 of the information terminal 1, and the program is executed by the calculation unit 104. This application may be an AI agent that executes inference processing on the information terminal 1 or an AI agent that executes inference processing on a computer other than the information terminal 1 via a network.

In the present embodiment, a smartphone is exemplified as the information terminal 1, but the present invention is not limited thereto. The information terminal 1 may be in the form of a wristwatch-type smartwatch, glasses-type smart glasses, a smart earphone worn on an ear, a ring-type smart ring, a smart speaker that performs voice operation, or a robot including a movable unit. The information terminal 1 according to the embodiment is an example of a communication terminal capable of communicating with the first computer.

The vehicle 2 includes at least a movable unit 201, an illumination 202, a sensor 203, a UI unit 204, a key control unit 205, a calculation unit 206, a memory 207, and a communication unit 208.

The movable unit 201 moves the vehicle 2 and moves devices (seats and the like) in the vehicle interior space.

The illumination 202 illuminates the surroundings of the vehicle 2 and the interior of the vehicle.

The sensor 203 detects a position and a state of a person and a vehicle around the vehicle 2, and further detects a position and a state of a person and an object inside the vehicle.

The UI unit 204 provides various video and audio information to an occupant (passenger) of the vehicle 2 and receives an input of a touch operation, an audio operation, or the like from the occupant.

The key control unit 205 authenticates a key to be unlocked and controls locking/unlocking of the doors of the vehicle 2.

The calculation unit 206 executes various processes related to a vehicle backbone system and a vehicle function. The calculation unit 206 is an example of a processor that records the AI model in the memory 207 and causes the software of the vehicle agent 20 executable in the in-vehicle system to be executed.

The memory 207 holds data and files used by the calculation unit 206. The memory 207 is an example of a memory that records at least one of access information including an address of an agent to be called (subpoenaed) to the in-vehicle system, agent attribute information regarding each agent, and an AI model for executing inference processing on the in-vehicle system. In addition, the memory 207 may record a use log of each agent by the user. In addition, the memory 207 may record a use log related to at least one agent available to the user. In addition, the memory 207 may record various data including a program of the vehicle backbone system and a database of key management.

The communication unit 208 performs wireless communication with an external device via the network N or the near field communication C. The communication unit 208 is an example of a communication device provided in the vehicle.

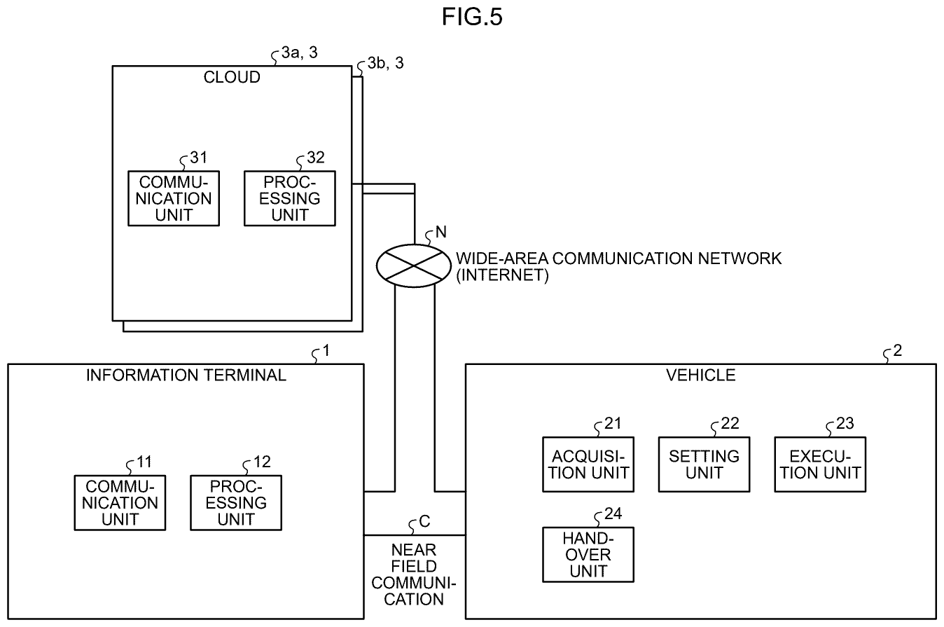

In the present embodiment, the UI unit 204, the key control unit 205, the calculation unit 206, the memory 207, and the communication unit 208 are implemented by an in-vehicle system of the vehicle 2. The memory 207 is an example of a memory that stores a program for causing the calculation unit 206 to execute predetermined information processing. The predetermined information processing includes processing executed by an acquisition unit 21, a setting unit 22, an execution unit 23, and a handover unit 24 (see FIG. 5) to be described later.

Note that the information terminal 1, the vehicle 2, and the cloud 3 may perform communication by other communication means of the network N. In one example, the near field communication C may be used for the unlocking process performed between the vehicle 2 and the information terminal 1.

The cloud 3 includes at least a communication unit 301, a memory 302, and a calculation unit 303.

The communication unit 301 communicates with another computer on a network N (wide-area communication network).

The memory 302 holds data and files used by the calculation unit 303. The memory 302 records information on the vehicle 2 and the user, a management program thereof, and the like.

The calculation unit 303 performs various types of data processing. The calculation unit 303 is an example of a processor for causing the cloud agent 30 (for example, a partner-type agent) to execute generation processing.

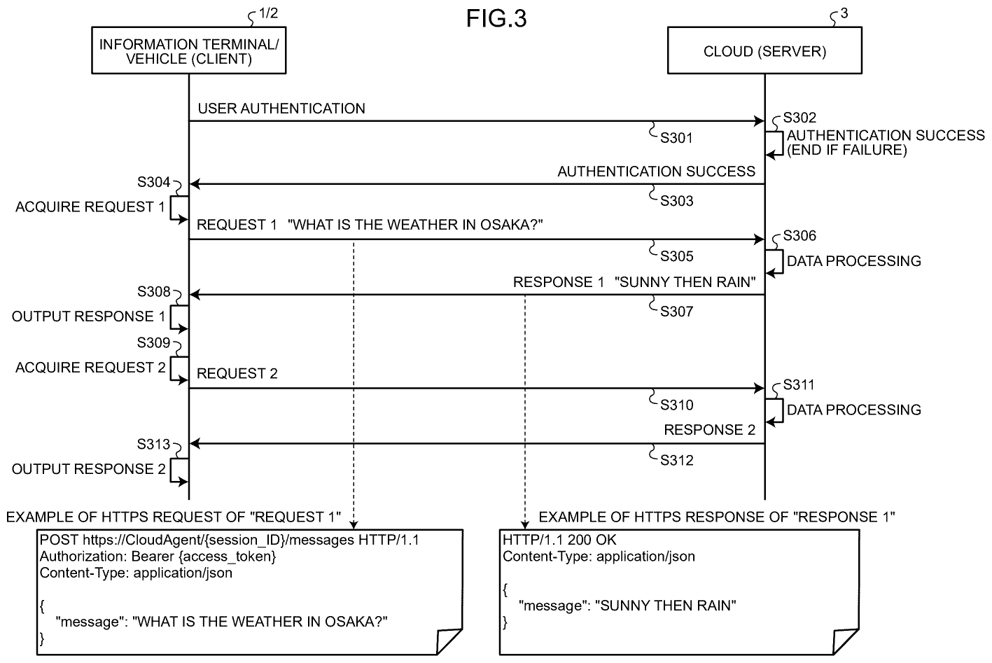

FIG. 3 is a sequence diagram illustrating an example of exchange by an API between a client (information terminal 1 or vehicle 2) and a server (cloud 3) via the network N in the human-agent interaction system according to the embodiment.

First, a premise of the human-agent interaction system according to the present embodiment will be described. As for the current AI, in many cases, for the convenience of operation resources for working a large-scale language model, the information terminal 1 (client) such as a smartphone is used as a UI terminal. The user inputs a question or a request to an app or a web browser of the information terminal 1 by text or voice. The app or web browser of the information terminal 1 transmits the input data to (an address or the like indicated by a URL (API endpoint) designated to use the AI model of) the cloud 3 through the API or the HTTP/HTTPS protocol. Hereinafter, the computer system that actually executes the inference processing of the AI model may be simply referred to as a server.

At least one computer that implements the client according to the embodiment is an example of the first computer. In addition, at least one computer that implements the server according to the embodiment is an example of the second computer.

The application programming interface (API) and the HTTP/HTTPS protocol are rules for communication between the app or the web browser of the information terminal 1 and the web app of the cloud 3, and have a role of exchanging data transmitted and received therebetween in a predetermined format (for example, HTTPS request/response). The cloud 3 that has received the request returns the response to the information terminal 1 in a predetermined format (for example, HTTPS response). The API and the HTTP/HTTPS protocol are responsible for authentication for ensuring security, transmission and reception of requests and responses, and the like. The cloud 3 (server) performs data processing and generates a response. The cloud 3 processes requests by utilizing a huge amount of calculation resources and a large amount of data. The inference processing using the AI model is executed on the cloud 3, performs data processing such as image processing, audio processing, data processing, and natural language processing in response to a request, and returns a response to the client by a predetermined data communication method. As a result, exchange between the agent and the user is performed.

In the configuration of the human-agent interaction system according to the present embodiment, the client that is the information terminal 1 or the in-vehicle system is a UI unit, the server that is the cloud 3 is a calculation unit that processes data and generates a response, and the API/protocol can be considered as a decision for performing data communication between the two different devices.

The client as the UI unit may be in any form as long as the client can acquire a request from the user and provide notification of a response, regardless of whether the client is the information terminal 1, the vehicle 2, or software operating on the information terminal 1 or the vehicle 2. In addition, the server as the calculation unit may be in any form as long as it can execute processing using the AI model in response to a request, generate a response, and send back the response, regardless of whether it is the cloud 3, the information terminal 1, the vehicle 2, or software operating on them. In other words, in a case where the client and the server are different devices, communication is performed by a predetermined API/protocol via the network, and processing is performed.

Note that, also in a case where the client and the server are implemented in one terminal (device), it is possible to perform processing by communicating with each other by a predetermined same API/protocol via a bus in the terminal, and the configuration of the human-agent interaction system according to the embodiment has a high degree of freedom of combination. Each embodiment of the present disclosure may be implemented in any form.

For example, the processing described as being executed by the information terminal 1 in FIG. 3 may be executed in an application acting as a client operating on the in-vehicle system of the vehicle 2. Alternatively, the processing described as being executed by the client and the server may be executed by each of the UI unit 103 and the calculation unit 104 in one information terminal 1. As long as the predetermined same API or protocol is used, the function of the UI unit (or client) in the human-agent interaction system may be implemented or executed in the information terminal 1 or the vehicle 2, and the function of the calculation unit (or server) that performs the inference processing of the AI model may be implemented or executed in the cloud 3 or the information terminal 1 or the vehicle 2. Of course, these may be implemented by software operating on the information terminal 1, the vehicle 2, and the cloud 3. Thus, all the disclosed content in the present embodiment can be implemented by any of these configurations, and may be implemented by any system configuration.

The client side such as the information terminal 1 requests the server side such as the cloud 3 for authentication of the user (S301). When the authentication of the user is successful (S302), the server side notifies the client side that the authentication of the user is successful (S303). When notification of the successful authentication of the user is provided the client side acquires a request of the user from communication (interaction or the like) with the user (S304), and transmits the acquired request to the server side (S305).

FIG. 3 also illustrates an example of the HTTPS request of “request 1” transmitted from the browser or app on the client side to the server side in the processing of S305. In the example of the HTTPS request, the first line indicates that the request is transmitted by the POST method of version 1.1 of HTTP with respect to the URL “https://CloudAgent/{session_ID}/messages”. The session ID of this communication session is described in “{session_ID}”. Further, in the second line, an access token used for authentication with the cloud 3 (server) on which the cloud agent 30 operates is specified in a portion of “{access_token}” in the Authorization header. The access token is a secret authentication code issued to a user or an application, and is used when the server approves a request. In addition, the third line is a Content-Type header and specifies that a data format to be transmitted is JSON. Then, the following is a request body, and the content of the transmission message is described in a JSON format. The text data “What is the weather in Osaka?” is described as the message.

The server side executes data processing in response to the request received from the client side (S306), and notifies the client side of the result as a response (S307).

FIG. 3 also illustrates an example of the HTTPS response of “Response 1” that is provided from the server side to the client side in the processing of S307. In the example of the HTTPS response, the first line indicates that the request is normally processed by returning a status code “200 OK” as a response. In addition, the second line is a Content-Type header and specifies that a data format to be transmitted is JSON. Then, the following is a response body, and a message to which the server responds is described in the JSON format. The text data “Sunny then rain” is described as the message.

Thereafter, the client side outputs (provides notification of) the response notification of which is provided to the user (S308). Thereafter, similarly, the client side and the server side repeat exchange of requests and responses (S309 to S313).

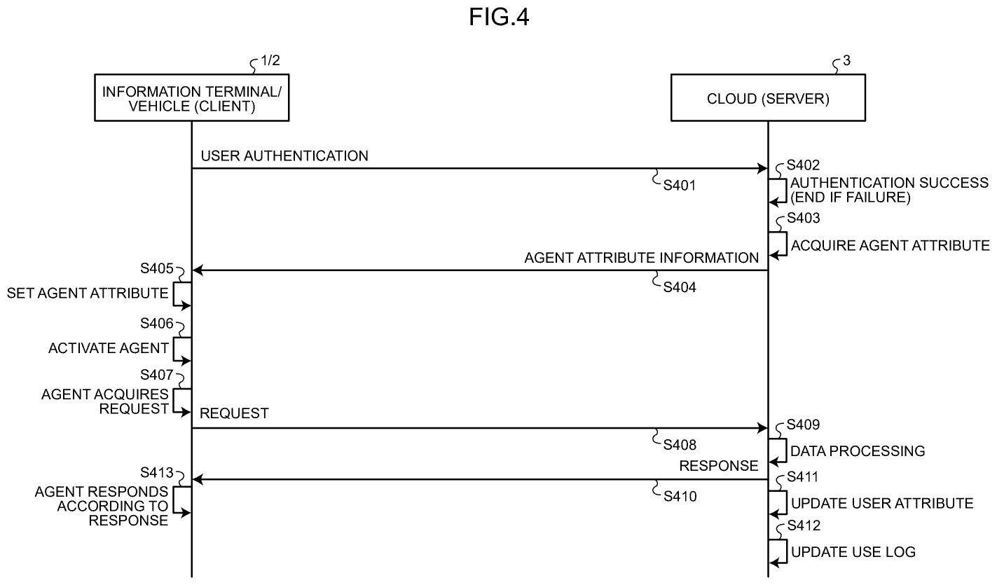

FIG. 4 is a sequence diagram illustrating an example of a procedure of processing in which the client downloads and uses agent attribute information in the human-agent interaction system according to the embodiment.

First, the client side requests the server side for authentication of the user (S401). When the authentication of the user is successful (S402), the server side acquires the agent attribute information of the agent designated in advance by the user (S403), and transmits the acquired agent attribute information to the client side (S404).

When receiving the agent attribute information, the information terminal 1 sets the agent attribute information (S405), and activates the agent based on the set agent attribute information (S406). As a result, the user recognizes the designated agent and understands that communication such as talking can be started according to the state of the agent expressed by the UI unit 103. Next, the activated agent acquires a request from the user's utterance content or the like (S407), and transmits the acquired request to the cloud 3 based on a predetermined protocol/API (S408). The cloud 3 executes data processing in response to the request received from the information terminal 1 (S409), and notifies the information terminal 1 of the result as a response based on a predetermined protocol/API (S410). The cloud 3 updates the user attribute information based on the exchange with the user (S411), and updates the agent use log (database in which date and time of exchange between the user and the agent, conversation content, and the like are recorded) (S412). In addition, the information terminal 1 responds to the user via the agent expressed by the UI unit 103 according to the received response (S413). Thereafter, the information terminal 1 and the cloud 3 repeatedly exchange requests and responses.

As described above, the client (first computer) interfaces the first interaction processing with the user by the agent (first AI agent) implemented on the server while being connected to the server (second computer).

Note that the user attribute information is, for example, a database including one or more of the user's name (nickname), age, sex, background, interest, preference, past conversation history, thoughts, experience, schedule information, external information/service with high use frequency or contracted, incomplete or unresolved task, device-specific information (identification information and access information) used by the user, biometric information, medical history, and behavior history (movement history).

Since the cloud 3 (server side) stores the agent attribute information, regardless of which information terminal 1 accesses the cloud 3, the agent attribute information can be expressed on that information terminal 1 (client). The agent attribute information is, for example, a data set used for expression of the agent including one or more of 3D model data (definition data of the appearance and the 3D physique structure of the agent including texture, clothes, and the like), animation data (expression, mouth, and gesture data for reproducing natural movement), voice data (data for reproducing the feature of the utterance of the agent), emotion data (data for reproducing a specific action pattern based on the emotion), and control script (control code for achieving consistency of the entire behavior of the agent at the time of operation or response).

In the cloud 3, a use log (user attribute information) in which exchange between the agent and the user is recorded and managed while being sequentially updated in the memory 302. As a result, it is possible to search for and answer or propose an event with the user in the past. For example, in a case where the user asks the agent about the final status of a certain specific matter, the agent can check the final status of the matter while referring to the conversation history in the user attribute information, and generate an answer. Such a technique is called retrieval-augmented generation (RAG), and is known as a natural language processing technique combining information retrieval and generative modeling.

In the cloud 3, user attribute information (interests, preferences, thoughts, etc.) obtained through exchange between the agent and the user may be updated in the memory 302. Moreover, by recording, managing, and updating information regarding the user's body of knowledge and experience as attribute information of the user, it is possible to give a response and a proposal based on the user's body of knowledge (exchange of details can be possible in the user's field of expertise) and experience (record data such as what the user has experienced in the past and events that have occurred).

The content of the request and the response may be text data such as text chat, video/still image data, audio data, or data subjected to other predetermined processing, or may be expressed as one of parameters included in the API or the like. Moreover, in a case where various sensors are provided on the client side such as the information terminal 1 on which an agent that exchanges with the user operates, different modal data other than the above text, image, and voice may be included in the content of the request and the response.

FIG. 5 is a diagram illustrating an example of a function configuration of the human-agent interaction system according to the embodiment.

In the vehicle 2 (in-vehicle system) according to the present embodiment, the calculation unit 206 executes a program recorded in the memory 207, thereby implementing the functions of the vehicle 2 (in-vehicle system) including the acquisition unit 21, the setting unit 22, the execution unit 23, and the handover unit 24. Note that each function of the vehicle 2 (in-vehicle system) including the acquisition unit 21, the setting unit 22, the execution unit 23, and the handover unit 24 may be implemented by collaboration (cooperation) with the information terminal 1 of the user or the cloud 3.

The acquisition unit 21 acquires the authentication information from the client. The authentication information may include information of an electronic key for the user to use the vehicle 2.

In response to determining that the authentication information is valid, the acquisition unit 21 acquires access information (for example, a connection destination address such as an API endpoint) for accessing an agent used by the user from a server (device) on which the agent is implemented or a computer accessible by an in-vehicle system of the vehicle 2 on the network. The acquisition of the access information may be executed in response to determining that the information regarding the agent available to the user is not registered in the memory 207 of the in-vehicle system based on the authentication information acquired from the client.

Moreover, in response to that the authentication information is valid, the acquisition unit 21 may establish a connection to a server on which a multimodal agent is executed. In this case, while the user is using the vehicle 2, the acquisition unit 21 acquires sensing data acquired via one or more sensors 101 provided in the information terminal 1 and one or more sensors 203 provided in the vehicle 2. The sensing data may be data including at least one of facial expression, gesture, emotion, and biometric information of the user, an indoor environment in the vehicle interior of the vehicle 2, a surrounding situation around the information terminal 1, a surrounding situation around the vehicle 2, a movement state of the information terminal 1, and a traveling state of the vehicle 2. The output data transmitted to the server based on the sensing data may include at least one of a type of data from which the sensing data is extracted, an identification code for identifying at least one of the information terminal 1, the vehicle 2, and a state and an event of the user, the state of the user, and a time stamp indicating a time when the event has occurred. Moreover, the multimodal agent is not limited to the cloud agent 30, and may be, for example, the smartphone agent 10 or the vehicle agent 20.

Then, the acquisition unit 21 converts the acquired sensing data into output data of a format and a type that can be supported by the agent for each unit of data acquired in a predetermined period of time. In response to determining that the authentication information is valid, the acquisition unit 21 may directly acquire data format information indicating a data format and a data type that can be supported by the agent (that is, the output data) from the client. In this case, the acquisition unit 21 may transmit the data acquired from the client to the server as it is as output data.

In a case where the agent is implemented on the information terminal 1 (server) capable of communicating via the network N or the near field communication C, the access information may include an address for accessing the agent in the information terminal 1 via the network N or the near field communication C. In addition, in a case where the agent is implemented on the cloud 3 (server) capable of communicating with the in-vehicle system of the vehicle 2 via the network N, the access information may include an address for accessing the agent in the cloud 3 via the network N.

The address included in the access information may be a global address for accessing an agent implemented in a server capable of communicating with the in-vehicle system via the network N, or a local address for accessing an agent implemented in a server capable of communicating with the in-vehicle system without the network N. Then, the connection to the information terminal 1 (server) may be executed via a common API even when the address included in the access information is either the global address or the local address. As a result, the in-vehicle system can be connected to both the agent on the server side and the agent on the edge side (the information terminal 1 such as a smartphone) using the common API.

In addition, the acquisition unit 21 acquires the agent attribute information for representing the character of the agent from the agent database implemented by the server on which the AI is implemented based on the access information. Thus, the acquisition unit 21 acquires the agent attribute information including the information of the UI of the agent and the like from the server. The agent database may be arranged in another computer with which the in-vehicle system of the vehicle 2 can communicate via the network N or the like.

In response to determining that the authentication information is valid, the acquisition unit 21 acquires access information for accessing the agent from the memory 207 or the like. Further, the acquisition unit 21 outputs (transmits) the agent attribute information for representing the character of the agent to the setting unit 22, and sets at least one of the GUI and the VUI based on the agent attribute information.

The setting unit 22 sets at least one of the GUI and the VUI representing the character of the agent in the execution unit 23 based on the agent attribute information.

While being connected to the server, the execution unit 23 uses a microphone and a speaker provided in the vehicle 2 to interface interaction processing with the user by an agent implemented on the connection destination server. Interfacing with the interaction processing with the user by the agent means performing exchange such as communication with the user by the agent expressed by the UI unit 204, acquiring a response or a request of the user, and conveying the response or the response to the request to the user.

Specifically, the execution unit 23 executes the interaction processing (communication) with the user according to the communication generated by the agent using at least one of the GUI and the VUI while being connected to the server on which the agent is implemented based on the access information. The GUI may be displayed on a display included in the UI unit 204. Moreover, the VUI may be input and output via a speaker and a microphone included in the UI unit 204. Moreover, in a case where the execution unit 23 receives a request from the user via the microphone of the UI unit 204 included in the in-vehicle system in a period of time during which the in-vehicle system cannot use the agent implemented in the server implemented by the external device, the vehicle agent 20 implemented in the in-vehicle system may execute response processing according to the request.

The handover unit 24 records a use log (first conversation log) related to the content of conversation between the agent and the user in the memory 207. Moreover, in a case where the network connection with the AI agent implemented by the external server is disconnected, the handover unit 24 causes an agent implemented in another available server to continuously execute the interaction processing with the user based on the use log (first conversation log).

In the information terminal 1 according to the present embodiment, the calculation unit 104 executes a program recorded in the memory 105 to implement each function of the information terminal 1 including a communication unit 11 and a processing unit 12. Note that each function of the information terminal 1 including the communication unit 11 and the processing unit 12 may be implemented by collaboration (cooperation) with an in-vehicle system of the vehicle 2 or the cloud 3.

In addition, in the cloud 3 according to the present embodiment, the calculation unit 303 executes a program recorded in the memory 302, thereby implementing each function of the cloud 3 including a communication unit 31 and a processing unit 32. Each function of the cloud 3 including the communication unit 31 and the processing unit 32 may be implemented by collaboration (cooperation) with the information terminal 1 or the in-vehicle system of the vehicle 2.

The communication unit 11 transmits authentication information for the user to use the vehicle 2 to the in-vehicle system of the vehicle 2. In addition, when the authentication information is determined to be valid, the communication units 11 and 31 transmit access information for accessing the agent to the in-vehicle system of the vehicle 2. Further, the communication units 11 and 31 transmit the agent attribute information for representing the character of the agent to the in-vehicle system of the vehicle 2, and cause the in-vehicle system to set at least one of the GUI and the VUI based on the agent attribute information.

When receiving a request by the user from the client side, the processing units 12 and 32 generate a response (response content) corresponding to the request by the implemented agent, and return the response to the client via the communication units 11 and 31.

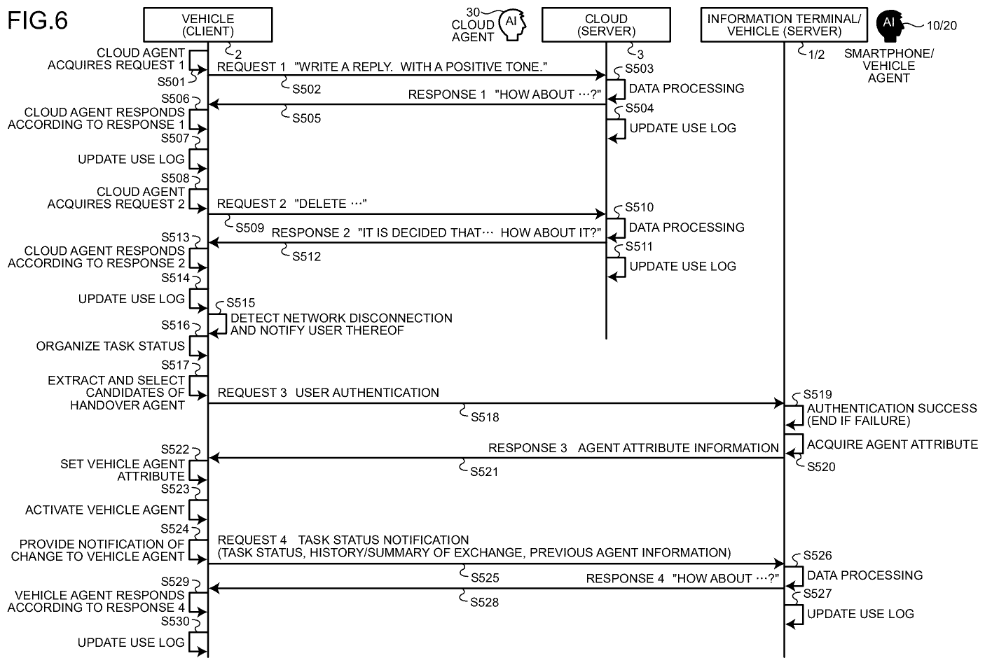

FIG. 6 is a sequence diagram illustrating an example of processing in which a network disconnection is detected and a server executing inference processing using an AI model is switched to an edge side in the human-agent interaction system according to the embodiment; This figure illustrates an example of a procedure of processing handed over from the cloud agent 30 to the vehicle agent 20.

A case where the connection of the vehicle 2 to the Internet is disconnected while the user is writing an email or a reply to an SNS while communicating with the cloud agent 30 via the in-vehicle system (client) of the vehicle 2 and the remaining tasks are handed over to the vehicle agent 20 which is one of the agents on the edge side (client side) will be exemplified. The agent on the edge side is, for example, an agent implemented on a device located in the surrounding space S (see FIG. 1) of the user. The agent may be referred to as an agent implemented on a device capable of communicating without the Internet. In the example of FIG. 1, the agent on the edge side may be the vehicle agent 20 as illustrated in the drawing, or may be the smartphone agent 10.

In the UI unit 204 of the client, a GUI or a VUI (function that is a physical representation of the cloud agent 30 and serves as a UI with the user) representing the cloud agent 30 is executed, the request 1 of the user is acquired (S501), and the acquired request is transmitted to the server according to a predetermined API/protocol (S502). The server executes data processing including inference processing (a response generation function serving as a brain of the cloud agent 30) using the AI model of the cloud agent 30 in response to the request received from the client (S503), updates the use log of the cloud agent 30 (S504), and notifies the client of the result in accordance with a predetermined API/protocol as a response (S505). In addition, in the client, the physical representation of the cloud agent 30 makes a response according to the response (S506), and the use log of the cloud agent 30 is updated (S507). Thereafter, the client and the server repeat the exchange of the request and the response, the physical representation of the agent in the UI unit of the client (the communication of the user via the GUI and/or the VUI), and the update of the use log (S508 to S514).

In the example of FIG. 6, the cloud agent 30 makes a response of “How about . . . ?” as a “response 1” to the “request 1” that is the user's “Write a reply. With a positive tone”. Moreover, in the example of FIG. 6, for example, the cloud agent 30 makes a response of “It is decided that . . . . How about it?” as a “response 2” to a “request 2” of “delete . . . ” from the user who has received a response according to the “response 1”.

A case where the client detects that the network connection is unstable or disconnected and notifies the user of the network disconnection (S515) will be described as an example.

The client organizes the progress status of the task that has been advanced by the user and the cloud agent 30 (S516), extracts candidates of the agent that can be handed over, and selects one or more agents of the handover destination from the extracted candidates of the handover agent (S517).

A case where the vehicle agent 20 capable of executing the inference processing using the AI model in the in-vehicle system of the vehicle 2 (capable of operating on the edge side without using the Internet) is selected as the agent of the handover destination will be described as an example.

The client requests the in-vehicle system (server) in which the selected vehicle agent 20 is implemented to authenticate the user (S518). When the authentication of the user is successful (S519), the server acquires agent attribute information of the vehicle agent 20 (S520), and transmits the acquired agent attribute information to the client (S521).

Upon receiving the agent attribute information of the vehicle agent 20 as the handover destination, the client sets the agent attribute information (S522), activates the vehicle agent 20 based on the set agent attribute information (S523), and notifies the user of the change from the cloud agent 30 to the vehicle agent 20 (S524). Moreover, the client transmits a request related to the handover of the task (task status notification) to the server (S525). The request (task status notification) includes at least one or more of a current task progress status, an exchange history and/or a summary thereof, and information regarding a previous agent, which are input to the agent of the handover destination.

The server executes data processing in response to the task status notification (task handover request) received from the client (S526), updates the use log of the vehicle agent 20 (S527), and notifies the client of the result as a response (S528). In addition, in the client, the GUI or the VUI (function that is a physical representation of the vehicle agent 20 and serves as a UI with the user) expressing the vehicle agent 20 is executed, and the response received by using the GUI or the VUI is expressed and provided in notification to the user (S529), and the use log of the vehicle agent 20 is updated (S530). Thereafter, the client and the server repeat, regarding the vehicle agent 20 as the handover destination, the exchange of the request and the response, the physical representation of the agent in the UI unit of the client, and the update of the use log (not illustrated).

The example depicted in FIG. 6 is a situation where the user has not responded to the “response 2” that is “It is decided that . . . . How about it?” from the cloud agent 30 before handover. Under such circumstances, the vehicle agent 20 of the server hands over the task in the middle state described therein based on the task status notification (request 4) received from the client, and makes a response of “response 4” such as “How about . . . ?”.

As described above, the client (first computer) interfaces the first interaction processing with the user by the agent (first AI agent) implemented on the server while being connected to the server (second computer). In addition, the client records a use log (first conversation log) related to the conversation content between the agent and the user implemented in the server in a memory in the client. In addition, in a case where the connection to the server becomes unstable or is disconnected, the client causes an agent (second AI agent) implemented in another server to execute the second interaction processing with the user based on the use log of the previous agent.

In addition, when executing the second interaction processing with the user based on the use log of the previous agent, the client detects disconnection of the connection to the server executing the first interaction processing, and then identifies one or more tasks requested to the previous agent before the disconnection based on the use log. Then, the client selects one agent capable of executing one or more tasks from one or more agents (second AI agents) implemented in another server. In addition, the client inputs task status information (request) including content and progress status of one or more tasks to the selected agent. As a result, the client causes the selected handover destination agent to execute the second interaction processing regarding one or more tasks based on the task status information.

As an example, the handover destination agent is an agent implemented in the information terminal 1 (another server or server software executed therein) or the in-vehicle system (another server or server software executed therein) that can communicate with the client (in-vehicle system or client software executed therein) via P2P. When the agent of the handover destination is the information terminal 1 (another server) that can communicate with the client via P2P, the client transmits a task status notification (request) to the information terminal 1.

Note that the task status notification (request information on task handover from the client to the server) described here may be exchange history information obtained by extracting at least a portion related to a latest topic from a use log recording an exchange history between the user and the agent. In that case, since processing such as analysis and summarization of the exchange is unnecessary, it is possible to simplify processing of generating a request for a task status notification in the client.

In addition, while the agent of the handover destination is executing the second interaction processing, the client also records the use log (second conversation log) related to the content of the interaction processing in the memory in the client. Then, in a case where connection to another server (for example, a previous server that executed the interaction processing before disconnection) is restored, the client transmits task status information generated based on the use log of the agent of the handover destination to the other server. As a result, the client interfaces the third interaction processing with the user by the agent of the handover destination after the restoration (for example, the first AI agent) using the microphone and the speaker provided in the vehicle 2 while connecting to the server that implements the agent of the handover destination after the restoration.

In addition, after detecting the restoration of the connection to another server (for example, the previous server that has executed the interaction processing before disconnection), the client identifies one or more tasks requested to the previous agent (first AI agent) before the connection is disconnected or newly requested to the agent of the handover destination in a period of time during which the connection is disconnected, based on the use log of the agent of the handover destination (second conversation log). Then, the client generates task status information including the content and progress status of one or more tasks, transmits the task status information to the server that implements the handover destination agent after the restoration (for example, the first computer), and causes the handover destination agent after restoration to execute the third interaction processing related to the one or more tasks based on the task status information (request).

In the human-agent interaction system according to the present embodiment, an application (app) that is installed in the client and controls the appearance and voice of the cloud agent 30 expressed by the UI units 103 and 204 of the client, namely, controls at least one of the GUI and the VUI is executed, and the exchange between the user and the cloud agent 30 is monitored and recorded. According to this configuration, even in a case where a situation in which the exchange between the client side and the server side cannot be suddenly performed as in the case of the network disconnection occurs, the remaining tasks can be smoothly handed over by another agent on the edge side such as the vehicle agent 20 based on the history of the dialogue so far. For example, in the case of a configuration in which the client operates on a browser basis, the client is operated with a specification in which the history of the exchange does not remain in the client, therefore such a method cannot be adopted. On the other hand, in a configuration in which the app that controls the appearance and voice of the cloud agent 30 interacting with the client is executed, a history of exchange can be left as a memory or a file, and a task in a middle state can be handed over to another agent in an emergency. In other words, the control app of the agent running on the client is not only for the interaction with the user but also for storing the exchange thereof, for example, in a short period of time, and thus has an unprecedented advantage that it is possible to request another available agent to continue the processing of the task in the middle at a time of the network disconnection or when a problem occurs on the connected cloud side and communication or processing cannot be performed.

Moreover, in the human-agent interaction system according to the present embodiment, in a situation where the client and the server cannot have the exchange with each other at the time of network disconnection or the like, agent candidates that can be handed over are searched for, and the agent of the handover destination is selected from the candidates. At this time, not only the vehicle agent 20 but also the smartphone agent 10 may be selected as the handover destination agent. The determination of the agent of the handover destination and the candidate thereof will be described later.

Moreover, in the human-agent interaction system according to the present embodiment, at the time of handover, the progress status of the task so far is organized and provided in notification to the handover destination agent on the edge side (the vehicle agent 20 in the example of FIG. 6). The task status notification is a handover document including one or more pieces of information of a task status, an exchange history and/or a summary thereof, and previous agent information. According to this configuration, the handover of the agent can be smoothly executed, and the UX can be improved. The UX related to the handover of the agent will be described later.

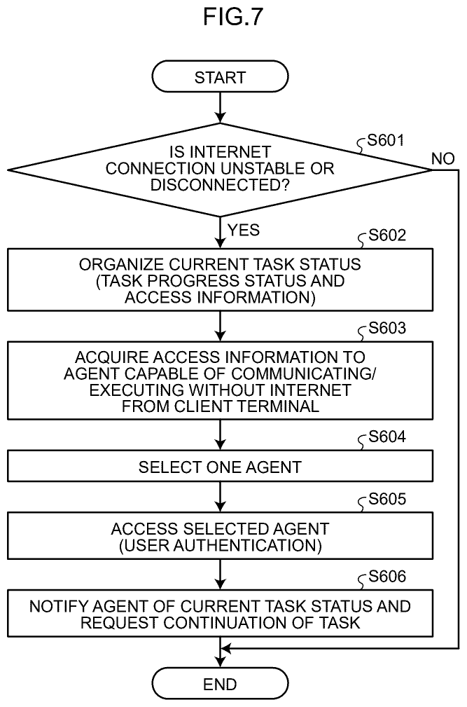

FIG. 7 is a flowchart illustrating an example of a procedure of processing in a case where the client (UI function providing side) changes the agent in the human-agent interaction system according to the embodiment.

The client or the software executed by the client (hereinafter the same) determines whether the Internet connection is unstable or disconnected (S601). When the Internet connection is stable or not disconnected (S601: No), the procedure of FIG. 7 ends. On the other hand, in a case where the Internet connection is unstable or disconnected (S601: Yes), the client organizes the current task status such as the task progress status (information included in the task status notification of FIG. 6) and the access information to the agent (S602), and acquires, from the client, the access information to the agent executed by a server capable of performing communication without the Internet or software executed by the server (the same applies hereinafter) and capable of executing the inference processing of the AI model without the Internet (S603).

The client selects one agent from among one or more agents capable of communicating and executing without the Internet (S604), and accesses the selected agent (user authentication) (S605). Specifically, the client requests the server executing the selected agent to authenticate the user. Then, when the authentication of the user is successful, the server acquires agent attribute information of the handover destination agent, and transmits the acquired agent attribute information to the client. In addition, upon receiving the agent attribute information of the handover destination agent, the client sets the agent attribute information, activates the handover destination agent based on the set agent attribute information, and notifies the user of the change to the handover destination agent.

In addition, the client requests the server to continue the task by a task status notification (request) notifying the server of the current progress status of the task (S606). Thereafter, the client and the server repeat, regarding the handover destination agent, the exchange of the request and the response, the physical representation of the agent in the UI unit of the client, and the update of the use log (not illustrated).

As described above, in the human-agent interaction system capable of interacting with the user, the cloud 3 (second computer) that is communicable with the in-vehicle system (first computer) provided in the vehicle 2 and on which the cloud agent 30 (first AI agent) used by the user is implemented executes the first interaction processing with the user by the cloud agent 30 via the in-vehicle system by using a microphone and a speaker provided in the vehicle 2 and used for a conversation with the user, a camera for reading a non-verbal response such as a facial expression of the user, a touch panel for receiving expression of intention by the user, or the like while being connected to the in-vehicle system. In addition, the in-vehicle system records a use log (first conversation log) related to conversation contents between the cloud agent 30 and the user in the memory 207 in the in-vehicle system of the vehicle 2. Then, the in-vehicle system identifies one or more tasks requested to the cloud agent 30 based on the use log, transmits task status information (request) including the content and progress status of the one or more tasks to the vehicle agent 20, which is an agent on the edge side, and causes the vehicle agent 20 (second AI agent) available to the in-vehicle system to execute the second interaction processing related to the one or more tasks based on the task status information.

Note that, in the above description, the task is handed over to the vehicle agent 20, but of course, the present disclosure is not limited to this, and a request to be handed over may be issued to other AI agents (for example, the smartphone agent 10) that can be used without the Internet.

Note that, in the above description, one or more tasks are identified based on the use log, but the present disclosure is not limited thereto, and part of the exchange of the most recent data of the use log may be transmitted to the AI agent as the handover destination as the task status information.

In the human-agent interaction system according to the present embodiment, the client can switch the agent in a case where communication with the agent in interaction is not possible, such as a case where the Internet connection is unstable or disconnected. For example, the client searches for an agent that can communicate with the client through peer to peer (P2P) without the network N by near field communication C such as Wi-Fi (registered trademark) or wired communication such as a USB cable, and that can be executed without requiring Internet connection at the time of executing inference of the AI model. Then, the client may select one agent from the agent candidates of the handover destination found, notify the server side that executes the selected agent of the task status to indicate the state of the task in the middle, and request the server side to hand over (continuation processing) the task.

Note that, in a case where the agent of the handover destination can be executed in the device of the client, namely, in a case where the agent of the handover destination can be executed on the device, one agent that executes handover including the own terminal may be selected.

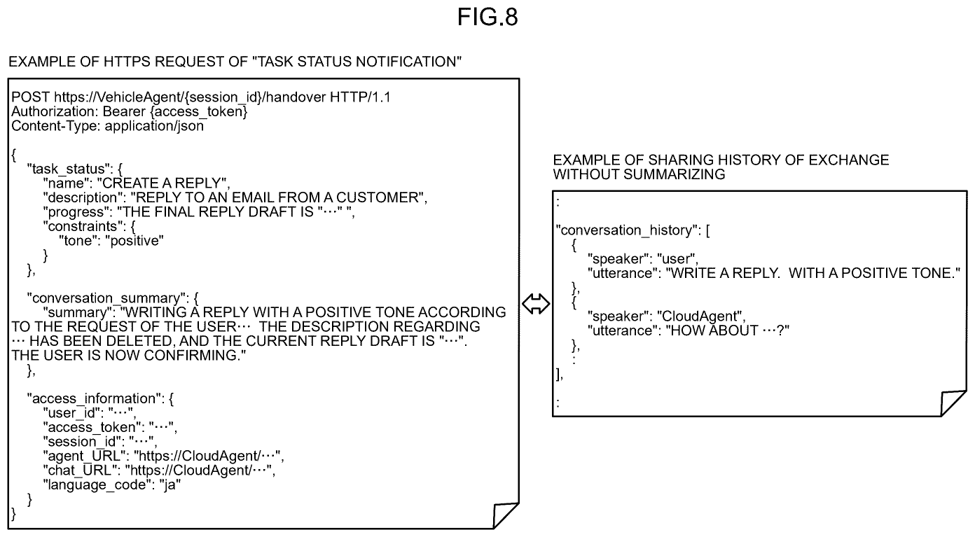

FIG. 8 is a diagram for describing an example of a data structure of the task status notification in the human-agent interaction system according to the embodiment.

With reference to FIG. 8, an example of the task status notification which is provided from the client to the server when a task is handed over or newly requested will be described. FIG. 8 illustrates a task status notification expressed as an HTTPS request. Note that, although it is described here that the client requests the server, the present disclosure is not limited thereto, and the AI agent of the server executing the AI model may voluntarily notify the AI agent on another Internet of the status of the task or request via the API to newly request the task. The task status notification described in the present disclosure can be universally used when some or all task processing is transferred from one AI agent to another AI agent.

In the example of FIG. 8, the first line of the task status notification for providing notification of the task status is a request line, and is an example indicating that handover of exchange identified by {session_id} performed between the cloud agent 30 and the user is requested to the vehicle agent 20 as the handover destination. The task status notification is information indicating the progress status of the task advanced by the user with the previous agent. The task status notification includes, for example, at least one of information of a task summary, information of a history of recent exchange between the user and the previous agent and/or the summary thereof, information of the user, the previous agent, and access information regarding the exchange therein.

The information of the task summary (task_status) is information related to the summary of the task requested by the user or set by the previous agent. The information of the task summary includes a name and an identification number (name) of the task, content (description), a current progress status indicating what is completed and what is a remaining task (progress), and information indicating constraints and conditions at the time of execution of the task (constraints).

The history of the latest exchange between the user and the previous agent or the information of the summary thereof includes text data expressing the exchange (at least one or more of the history of when, who, and what the person conveyed) or information of the summary (conversation_summary). The summary information may be, for example, text data that briefly includes determined items and pending items, user's intention, constraints and restrictions, and the like regarding the exchange between the user and the previous agent.

The information of the user, the previous agent, and access information regarding the exchange therein (access_information) includes the user authentication information (user_id), the access token or the API key given to the user or the app (access_token), the information identifying the exchange between the user and the previous agent (session_id), the access information of the agent (agent_URL), the link to the text log indicating the exchange with the agent (chat_URL), and the information indicating the language setting used by the user (language_code).

Note that these pieces information are examples, and similar forms may be expressed in different types and forms of data, or may be implemented as an API without being limited to the form of an HTTP request.

Moreover, as an example of the text data expressing the exchange mentioned in the above description (at least one or more of the history of when, who, and what the person conveyed), a case where the exchange history is shared without being summarized is illustrated on the right side of the drawing. Information for identifying whether it is the utterance of the user or the AI agent (speaker) and information indicating the utterance content (utterance) may be paired and described in chronological order as the exchange history (conversation_history).

Note that the exchange history or summary included in the task status notification described here is not limited to text data. For example, it may be audio data obtained by recording audio of the exchange between the user and the agent, or may be video data obtained by recording the scene of the exchange. The latest exchange between the user and the agent may be recorded in the task status notification, and various forms are conceivable for the data format.

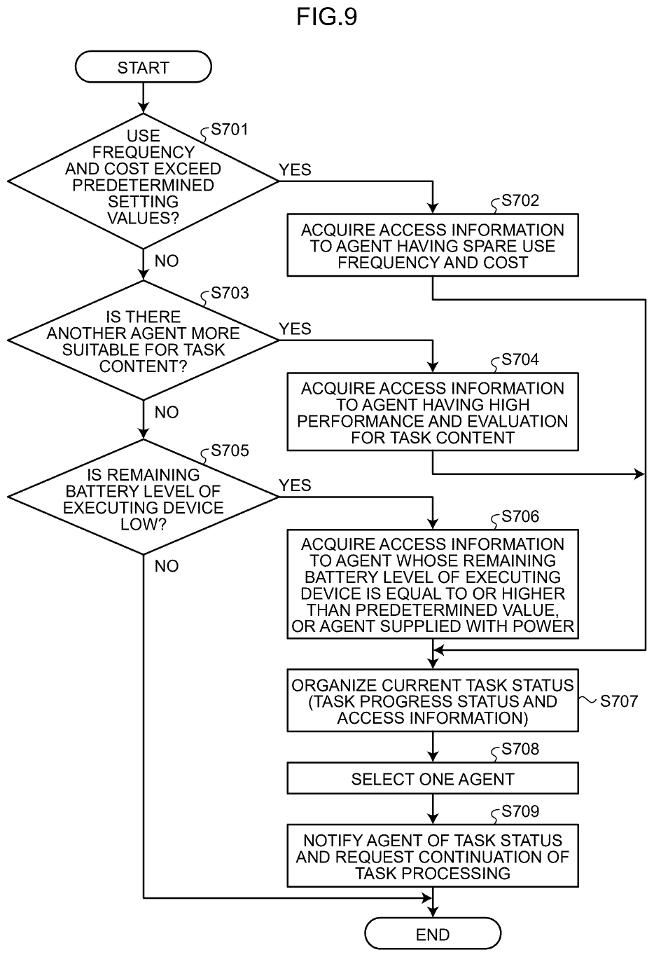

FIG. 9 is a flowchart illustrating an example of a procedure of processing in a case where the server (a computer executing inference processing of AI model or software executed therein) changes the agent in the human-agent interaction system according to the embodiment.

The server determines whether the use frequency and the cost exceed predetermined setting values (S701). In a case where the use frequency and the cost exceed the predetermined setting values (S701: Yes), the server acquires access information to an agent having spare use frequency and cost (S702). Thereafter, the procedure of FIG. 9 proceeds to the processing of S707.

In a case where the use frequency and the cost do not exceed the predetermined setting values (S701: No), the server determines whether or not there is a more appropriate agent for the task content, namely, an agent more suitable than the agent that executes the interaction processing at that time (S703). In a case where there is a more appropriate agent for the task content (S703: Yes), the server acquires access information to an agent having high performance and high evaluation for the task content (S704). Thereafter, the procedure of FIG. 9 proceeds to the processing of S707.

In a case where there is no more appropriate agent for the task content (S703: No), the server determines whether the remaining battery level of the device of the server executing the inference using the AI model is less than a predetermined threshold (S705). In a case where the remaining battery level of the device being executed is equal to or higher than the predetermined threshold (S705: No), the procedure of FIG. 9 ends.

In a case where the remaining battery level of the device being executed is lower than the predetermined threshold (S705: Yes), the server acquires access information to an agent whose remaining battery level of the device being executed is equal to or higher than a predetermined value and/or an agent that is supplied with power (S706).

Thereafter, the server organizes the current task status such as the task progress status and the access information (S707), and selects one handover destination agent according to the acquired access information (S708). Then, the server requests the server side that executes the handover destination agent to continue the task in response to a task status notification that notifies the selected handover destination agent of the current task status (request) or a task execution request via the API (S709). Note that this notification may be performed via a client or may be directly performed between servers. Thereafter, the client and the server repeat, regarding the handover destination agent, the exchange of the request and the response, the physical representation of the agent in the UI unit of the client, and the update of the use log (not illustrated).

As described above, in the human-agent interaction system capable of interacting with the user, the cloud 3 (second computer) that is communicable with the in-vehicle system (first computer) provided in the vehicle 2 and on which the cloud agent 30 (first AI agent) used by the user is implemented executes the first interaction processing with the user by the cloud agent 30 by using a microphone and a speaker provided in the vehicle 2 and used for a conversation with the user, a camera for reading a non-verbal response such as a facial expression of the user, a touch panel for receiving expression of intention by the user, or the like while being connected to the in-vehicle system. In addition, the cloud 3 records a use log (first conversation log) related to the content of conversation between the cloud agent 30 and the user in the memory 302 in the cloud 3. Further, the cloud 3 identifies one or more tasks requested to the cloud agent 30 based on the use log, transmits task status information (request) including the content and progress status of the one or more tasks to the in-vehicle system, and causes the vehicle agent 20 (second AI agent) available to the in-vehicle system to execute the second interaction processing related to the one or more tasks based on the task status information.

In the human-agent interaction system according to the present embodiment, it is also possible to perform handover that is not caused by network disconnection as described above. Specifically, in the human-agent interaction system, in a case where the cloud agent 30 determines that one or more tasks cannot be processed or should not be processed, handover is performed to another agent. For example, it is conceivable to hand over a part or all of the task to another agent for reasons such as limitation due to a use contract or a fee of the AI model, reduction of a calculation load of the cloud 3 (server side), leaving processing to an agent suitable for the task, or a decrease in a remaining battery level of an edge terminal (client) executing the AI model. In this case, the server executing the agent may notify the computer system that can be another server executing another agent of the handover destination of the task status and request the handover.

In a case where the use frequency exceeds the setting value, such as a case where the limit of the number of API calls within a predetermined time or the upper limit of the input/output token amount is exceeded, or in a case where charging according to the use frequency occurs and the cost exceeds the setting value, the server can hand over the interaction processing to one of agents that can be used for free or agents that still have room for the setting value.

In a case where there is another agent that can be evaluated as having a higher performance capability or having a higher performance capability by a predetermined amount or more for the task content, the server may hand over the subsequent processing to the agent having a higher performance capability. Note that the server may request another server to process a specific task via an API or the like to return a result of processing the task so as not to cause the handover to the agent.

In a case where the remaining battery level of the device that implements the server is lower than a predetermined value, such as a case where the in-vehicle system is tethered by Wi-Fi (registered trademark) to cause the information terminal 1 to execute AI processing and the information terminal 1 is not sufficiently charged, the server can hand over to a device having a remaining battery level or an agent that is executed on a power-supplied device.

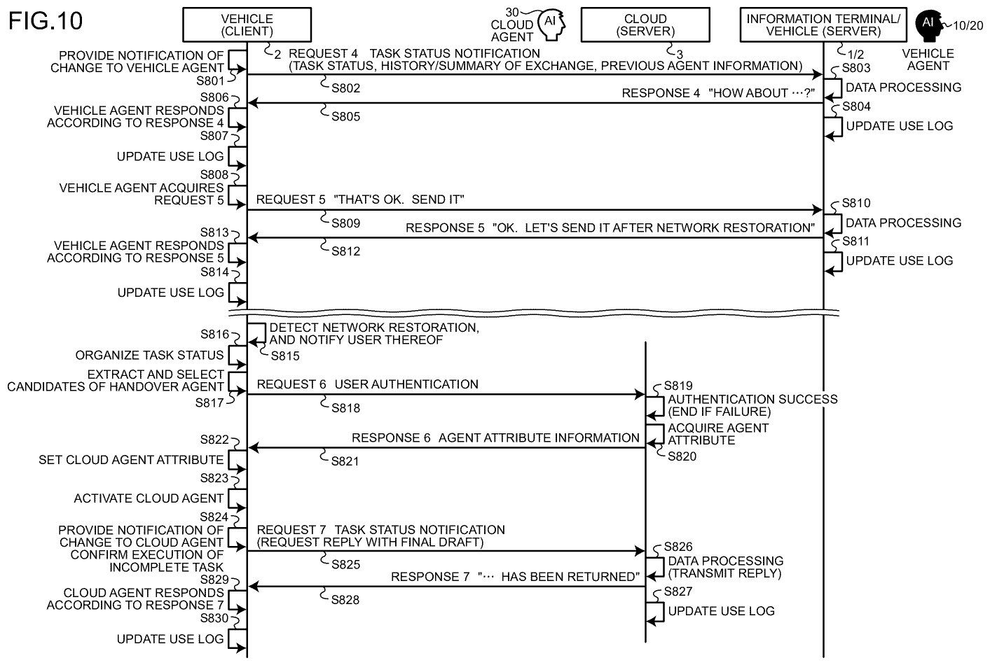

FIG. 10 is a sequence diagram illustrating an example of a procedure of processing handed over from the vehicle agent 20 to the cloud agent 30 along with the network restoration in the human-agent interaction system according to the embodiment.

After notifying the user of the switch to the vehicle agent 20 by the network disconnection or the like (S801), the client transmits a request related to the task status (task status notification) to the server that executes the vehicle agent 20 as the handover destination (S802). The server executes data processing in response to the task status notification (request) received from the client or the API for requesting the handover (or execution) of the task (S803), updates the use log of the vehicle agent 20 (S804), and notifies the client of the result as a response (S805). Further, in the client, the vehicle agent 20 as the user interface expressed by the UI unit 204 responds to the user according to the response (S806), and updates the use log of the vehicle agent 20 (S807). Thereafter, the client and the server repeat, regarding the vehicle agent 20 as the handover destination, the exchange of the request and the response, the physical representation of the vehicle agent 20 in the UI unit of the client, and the update of the use log (S808 to S814).

The example depicted in FIG. 10 is a situation where the user has not responded to the “response 2” that is “It is decided that . . . . How about it?” from the agent before handover (for example, the cloud agent 30) (see FIG. 6). Under such circumstances, the vehicle agent 20 hands over the task of the cloud agent 30 based on the task status notification (request 4 in FIG. 10) received from the client, and makes a response of “How about . . . ?” as “response 4”. Moreover, for example, in the example of FIG. 10, for “request 5” that is “That's OK. Send it” from the client, a response of “OK. Let's send it after network restoration” is made as “response 5”.

Thereafter, the description will be continued using, as an example, a case where restoration of the Internet connection (network restoration) is detected in the client and the user is notified of the network restoration (S815).

The client organizes the task status of the vehicle agent 20 before the restoration (S816), extracts a candidate of an agent to be handed over after the restoration, and selects one or more agents of the handover destination after the restoration from the extracted candidate of the handover agent (S817).

A case where the cloud agent 30 is selected as the handover destination agent after restoration will be described as an example.

The client requests the cloud 3 (server) in which the selected cloud agent 30 is implemented to authenticate the user (S818). When the authentication of the user is successful (S819), the server acquires agent attribute information of the cloud agent 30 (S820), and transmits the acquired agent attribute information to the client side (S821).

Upon receiving the agent attribute information of the handover destination cloud agent 30 after the restoration, the client sets the agent attribute information (S822), executes physical expression of the cloud agent 30 by the UI unit 204 based on the set agent attribute information (S823), notifies the user of the change to the cloud agent 30, and confirms the user to execute the incomplete task (S824). Moreover, the client transmits a request related to the task status (task status notification) to the server (S825).

The server executes data processing in response to the task status notification (request) received from the client or the API for requesting the handover (or execution) of the task (S826), updates the use log of the cloud agent 30 (S827), and notifies the client of the result as a response (S828). In addition, the client executes the physical representation of the cloud agent 30 according to the received response (S829), and updates the use log of the cloud agent 30 (S830). Thereafter, the client and the server repeat, using the cloud agent 30 of the handover destination after the restoration, the exchange of the request and the response, the physical representation of the agent in the UI unit of the client, and the update of the use log (not illustrated).

In the example depicted in FIG. 10, the task status of the vehicle agent 20 before the restoration is a status in which the final draft has been completed and only the reply is the remaining task. Under the circumstances, the cloud agent 30 as the handover destination after the restoration takes over the remaining task of the vehicle agent 20 based on the task status notification (request 7), which is received from the client side, that requests a reply with the final draft or the API describing the equivalent request, transmits a reply with the final draft that has been confirmed, and makes a response of “ . . . has been returned” as the “response 7”.

As described above, in the human-agent interaction system according to the present embodiment, when the network is restored, the agent control app of the client accesses the cloud agent 30 and provides notification of the task status, and the cloud agent 30 of the handover destination after the restoration can perform the incomplete task of the vehicle agent 20 before the handover.

Specifically, in the human-agent interaction system according to the present embodiment, an app that controls the appearance and voice response of the agent is running on the device of the client, and the app monitors and records the exchange between the user and the agent before the restoration (the vehicle agent 20 in the example of FIG. 10). Therefore, when the network is restored, it is possible to organize the history so far and smoothly hand over the remaining task to the agent as a handover destination after restoration (the cloud agent 30 in the example of FIG. 10). For example, in the case of a configuration in which the client operates on a browser basis, it is common that no history of exchange is left, and this cannot be performed. On the other hand, in the configuration in which the app that controls the appearance and voice conversation of the agent interacting with the client is executed, it is possible to leave a history of the exchange as a memory or a file, and thus, it is possible to accurately request another agent to execute the incomplete task (or new task) based on the past exchange history.

The use log (second conversation log) of the handover destination agent at the time of the network disconnection is divided into one or more segments corresponding to one or more tasks and managed on the memory in the client. In addition, the task status information may include a summary sentence obtained by summarizing a segment corresponding to a task to be handed over to the agent (for example, the first AI agent) of the handover destination after the restoration in the use log.

Moreover, in the human-agent interaction system according to the present embodiment, the task status is organized and provided in notification to the handover destination agent at the time of network restoration. According to this configuration, the handover of the agent can be smoothly executed, and the UX can be improved. The UX related to the handover of the agent will be described later.

Note that the handover of the agent at the time of network restoration may be started by the agent of the handover destination at the time of network disconnection (the vehicle agent 20 in the example of FIG. 10). For example, the vehicle agent 20 that has detected the network restoration may transmit a task status notification to the agent that has handed over (the cloud agent 30 in the example of FIG. 10) and request handover. As a result, the cloud agent 30 may resume the exchange with the user, summarize the exchange with the vehicle agent 20 or look back on the history of the exchange in chronological order, and confirm the execution of the incomplete task to the user.

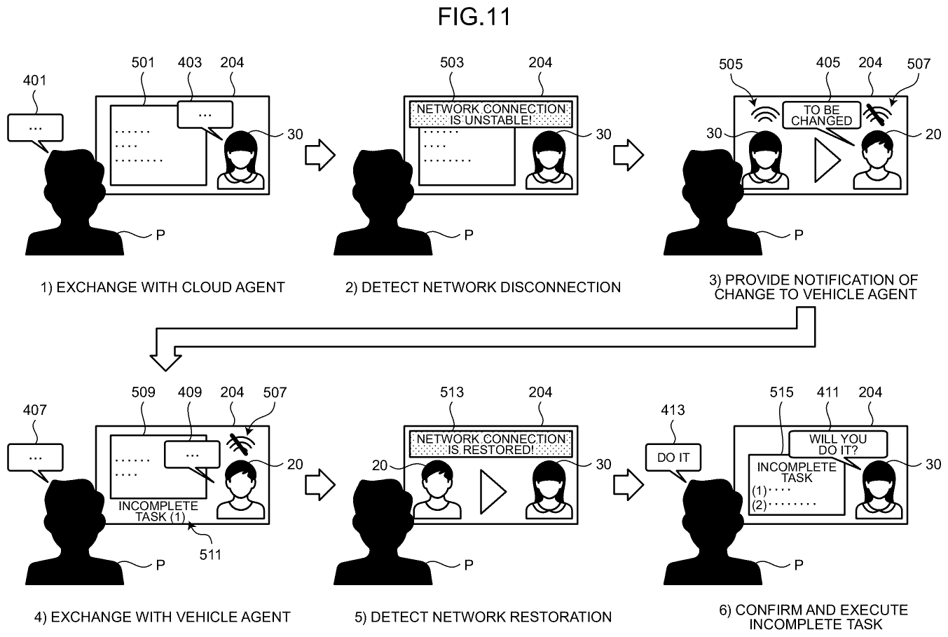

FIG. 11 is a diagram illustrating an example of a notification in the human-agent interaction system according to the embodiment.

An example of the UX related to agent handover will be described with reference to FIG. 11. FIG. 11 illustrates a display layout of the agent.

In a case where the agent is displayed on the UI unit 204 of the vehicle 2 (in-vehicle system), the agent (first object) executing the interaction processing at that time is arranged on the side farther from the user P in the horizontal direction in the display region of the UI unit 204. The arrangement of an agent in the display region of the UI unit 204 means displaying an object representing a character of the agent in the display region. Moreover, for example, information 501 and 509 (in this case, a sentence transmitted to the user P such as a mail and/or a sentence being created as a reply) displayed to the user P is arranged closer to the user P in the horizontal direction. The arrangement of the information 501 and 509 in the display region of the UI unit 204 means displaying an object (second object) including letter information for the user P in the display region. In other words, displaying the information to be presented to the user P at a position closer to the user P and displaying the agent at a position farther from the user P is set as the normal layout.

Note that the information 515 (in this example, information of the incomplete task) displayed to the user P is also an object including letter information for the user P, similarly to the information 501 and 509.

In the example of FIG. 11, since the user P speaking voices 401, 407, and 413 is seated on the left side of the display region of the UI unit 204, the vehicle agent 20 and the cloud agent 30 that are interacting at that time are displayed on the right side as viewed from the user P. Moreover, the sound around the user P or the sound outputs of the left and right speakers may be adjusted so that the voices 403, 405, 409, and 411 from the agent can be heard from the direction of the display position of the agent. In the example of the drawing, the voice output of the right speaker of the user P may be controlled to be larger than the voice output of the left speaker so that the voice of the agent can be heard to be large from the right side of the user P.

In a case where the connection to the network N is unstable or the network disconnection is detected, a notification 503 such as “NETWORK CONNECTION IS UNSTABLE!” is superimposed on another display or arranged in an easy-to-understand position, size, and color arrangement in the display region of the UI unit 204. This notification 503 is an example of a notification to the user when the connection to the network N is unstable or the network is disconnected.

In a case where the network connection is unstable and notification of the switching to the vehicle agent 20 is provided, in the display region of the UI unit 204, the previous cloud agent 30 is arranged closer to the user P in the horizontal direction, and the vehicle agent 20 of the handover destination is arranged farther. Alternatively, the previous agent may be arranged on the left side when viewed from the user P and the agent after handover may be arranged on the right side according to the convention of the expression of the chronological change. At this time, in the display region of the UI unit 204, icons 505 and 507 indicating the presence or absence of connection to the network N may be arranged together with each agent. In the example of FIG. 11, an agent that can use the Internet connection or the icon 505 indicating that the Internet connection is available is arranged together with the cloud agent 30 before the network disconnection. In addition, an agent for which Internet connection is unavailable or the icon 507 indicating an unavailable state is arranged together with the vehicle agent 20 of the handover destination. The icon 507 may be arranged in the display region of the UI unit 204 until the network connection is restored.

When an incomplete task is created in the exchange with the handover destination agent, the information 511 indicating the number of incomplete tasks or the content thereof is displayed in the display region or is provided in notification by voice. The information 511 is an example of letter information directed to the user P, and is an example of information of at least one incomplete task that has been requested by the agent but has not yet been completed. Moreover, the display of the information 511 is kept and updated even after the interaction processing by the handover destination agent is started. Therefore, the user P can easily understand how many incomplete tasks are present while having various exchanges with the agent while being offline. In addition, when the incomplete task is finally executed, since the user P remembers the incomplete task well, it is possible to easily confirm that there is no omission in the list of the incomplete tasks.

In a case where the restoration of network connection is detected, a notification 513 such as “NETWORK CONNECTION IS RESTORED!” is superimposed on another display or arranged in an easy-to-understand position, size, and color arrangement in the display region of the UI unit 204. This notification 513 is an example of a notification to the user of network restoration.

In the display region of the UI unit 204, after the network restoration, the cloud agent 30 arranges the information 515 indicating the tasks remaining as the incomplete tasks, and finally confirms the execution of the tasks to the user P. The information 515 is an example of letter information directed to the user P, and is an example of information of at least one incomplete task that has been requested by the previous agent but has not yet been completed.

When the user P takes an acceptable reaction, the agent performs and completes these incomplete tasks. The reaction accepted by the user P may be, for example, a touch of an OK button of the UI unit 204, may be a voice 413 of utterance such as “execute the incomplete task” or “do it”, or may be a gesture indicating affirmation such as nodding to an agent's question. The agent of the handover destination after the restoration (the cloud agent 30 in the example of FIG. 11) may monitor whether all the incomplete tasks have been executed, and in a case where all the incomplete tasks have been successfully completed, may notify the user of the fact. Thereby, the user P can clearly recognize that all the incomplete tasks have been completed. In addition, in a case where some or all of the tasks cannot be completed, the user may be notified of the fact, and the task may be displayed in the display region as an incomplete task, or the voice notification may be continued.

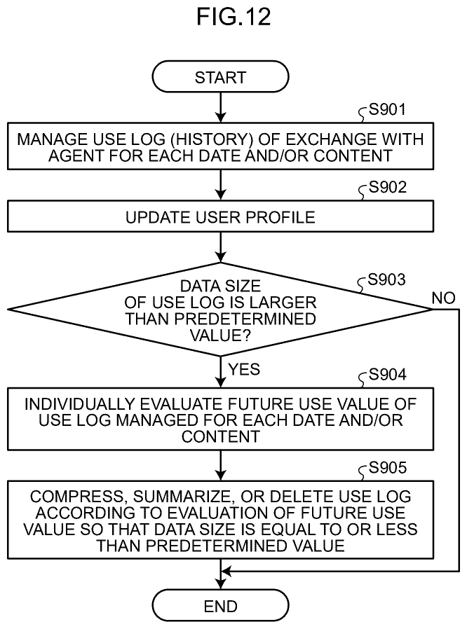

FIG. 12 is a flowchart illustrating an example of a procedure of processing of managing a use log of a partner-type agent in the human-agent interaction system according to the embodiment.

First, the server manages a use log (history) of exchange between the user and the agent for each of at least one of the date and the content (S901). In addition, the server determines and stores the body of knowledge, the interest target, and the experienced matter of the user from the exchange with the user, and records and manages data simply expressing them as user profile data (or user attribute information) in the memory of the server (S902).

In addition, the server determines whether or not the data size of the use log is larger than a predetermined value (S903). In a case where the data size of the use log is equal to or smaller than the predetermined value (S903: No), the procedure of FIG. 12 ends. On the other hand, in a case where the data size of the use log is larger than the predetermined value (S903: Yes), the server individually evaluates the future use value of the use log managed for each at least one of the date and the content (S904), and compresses, summarizes, or deletes the use log according to the evaluation of the future use value, such that the data size is equal to or less than the predetermined value (S905). Note that the predetermined value for the data size after compression, summarization, or deletion may be the same as or smaller than the predetermined value of the data size used in the processing of S903.

Note that the procedure of FIG. 12 is not limited to the server, and may be executed by the client.

As described above, in the human-agent interaction system according to the present embodiment, the use log of the partner-type agent is managed separately for each date and content. As an example, a computer on which an AI agent capable of interacting with a user is implemented executes an interaction processing with the user by the AI agent. In the memory of the computer, a history of using the AI agent is recorded as a plurality of use logs that is divided for each date, for each content, or for each date and content. Then, when the data size of the plurality of use logs exceeds a predetermined value, the computer evaluates the future use value of each of the use logs, and compresses, summarizes, or deletes each of the use logs according to the future use value.

It is conceivable that a use fee of the partner-type agent is charged based on the storage fee of the use log (payment for becoming intelligent as the training data increases as the usage increases) and a use fee of the AI model (payment for the usage of the intelligent model). As the user frequently uses the partner-type agent that supports the user side by side every day, the use log becomes enormous, and the management cost thereof is increased. In addition, when the use log becomes large, it becomes difficult to perform search with the RAG due to the processing time and memory restrictions. In addition, at the same time, there is also a concern of an increasing use logs that are difficult to use as training data for enhancing exchange with the user in the future, such as information that is useful only at that time (such as the current congestion situation of the road).

Under such circumstances, in the human-agent interaction system according to the present embodiment, use logs are managed separately for each of the user who has the exchange with, the date, and the content thereof, and if the use log is determined to be a use log having high use value at the time of generating a response in the exchange with the user, the detailed data size is left in a state of a large size, and if the use log is determined to be having low value, the size is reduced by summarizing, or if the use log data is a moving image or audio data, the size is reduced by compressing the data at a higher compression rate, or the use log data itself is deleted, thereby reducing the size. In addition, it is also conceivable that the user instructs to summarize/delete all use logs related to a certain item. In this configuration, it is easy to search for the corresponding use log according to the instruction (setting) of the user, and the target use log may be summarized/deleted.

Moreover, in the human-agent interaction system according to the present embodiment, the future use value of the use log may be determined by, for example, a calculation unit of a device that implements a server, and may be recorded and managed in a memory provided in the device.

The future use value of the use log may be determined as an evaluation value that is evaluated to be higher as the possibility that the user browses the use log data in the future is higher, and to be lower as the possibility is lower. For example, the future use value may be highly evaluated in the case of video data obtained by capturing a family member or a friend of the user, and may be low evaluated in the case of a route to a certain destination searched by the user on a certain day or traffic condition data at that time.

Moreover, the future use value of the use log may be determined as an evaluation value that is evaluated to be higher as the possibility that the use log data is referred to for generating future exchange with the user is higher, and to be lower as the possibility is lower. In one example, the future use value may be highly evaluated in the case of information regarding the user's background, work content, interest, and family structure, and may be low evaluated if the information is determined to be easily searched on the Internet.

Moreover, in the human-agent interaction system according to the present embodiment, the agent may perform the exchange according to the knowledge and the interest level based on the user attribute information in which the user's body of knowledge, the interest target and the experienced matter are determined and stored from the exchange with the user.

In addition, in the human-agent interaction system according to the present embodiment, an AI model trained to make the same determination and reaction as the user may be created from the user attribute information and the use log, and simple information processing and determination of pre-judgment may be performed using the AI model. In a case where introduction of a specific product or service is transmitted to the user (e-mail distribution, advertisement display on web/SNS, etc.), when the AI model that has been trained the determination or reaction of the user from the user attribute information or the use log determines that the interest degree of the user in the product or service is low, such advertisement or information distribution may be regarded as having a low priority, may be rejected to be received, may be treated not to be displayed, or the information received may be discarded. On the other hand, the partner-type agent may be operated to curate an SNS post, news, or the like the user is interested in, so as to be introduced to the user or to be reported as a report regularly or in an event-driven manner.

Note that, in the above-described embodiment, the case where the agent capable of interaction correlated with the user is implemented in the human-agent interaction system including the vehicle 2 has been exemplified, but the present invention is not limited thereto. The human-agent interaction system according to the present disclosure may be implemented including a computer system provided in a space such as a house, an office, or a store in addition to or instead of the vehicle.

In a case where there is a computer system that controls home appliances and facilities of a house (for example, an IoT system using a smart speaker as a hub) and a user can communicate with the computer system using a natural language, the computer system is equivalent to the in-vehicle system in the vehicle 2. Therefore, what can be achieved with the configurations of the information terminal 1, the vehicle 2 (in-vehicle system), and the cloud 3 described in the present disclosure can be similarly achieved with the configurations of the information terminal 1, the house (smart speaker), and the cloud 3.

Note that, in each of the above-described embodiments, the GUI and the VUI have been described as communication means between the AI agent and the user. However, an intention expression means via a physical operation (PUI) may be used, an intention expression means via a body motion of the user (NUI) may be used, or two or more of these intention expression means may be combined and implemented.

Note that, in each of the above-described embodiments, the determination of “whether or not it is A” may be implemented by determining only “It is A”, may be implemented by determining only “It is not A”, or may be implemented by determining both of them.

In each of the above embodiments, “any of A” means “at least one of A”.

Note that a computer program executed by each of devices in the human-agent interaction system according to each of the above-described embodiments is also provided by being recorded in a non-transitory computer-readable recording medium (Computer Program Product) such as a CD-ROM, a FD, a CD-R, or a DVD as a file in an installable format or an executable format.

Moreover, the computer program executed by each of devices in the human-agent interaction system according to each of the above-described embodiments may be stored in a computer connected to a network such as the Internet and provided by being downloaded via the network. In addition, the program executed by each of devices in the human-agent interaction system according to the above-described embodiments may be provided or distributed via a network such as the Internet.

In addition, the computer program executed by each of devices in the human-agent interaction system according to each of the above-described embodiments may be provided by being stored in advance in a memory such as ROM or the like.

According to at least one embodiment described above, it is possible to appropriately switch the agent with which the interaction correlated with the user is possible. Therefore, even in a situation where the agent is switched, the task can be appropriately handed over before and after the switching.

While certain embodiments have been described, these embodiments have been presented by way of example only, and are not intended to limit the scope of the inventions. Indeed, the novel methods and systems described herein may be embodied in a variety of other forms; moreover, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing method executed by a first computer, the first computer being provided in a vehicle in a human-agent interaction system capable of interacting with a user, the method comprising:
interfacing first interaction processing with the user by a first AI agent implemented on a second computer on a network by using a microphone and a speaker provided in the vehicle, the interfacing being performed while being connected to the second computer via a communication device provided in the vehicle or via a communication terminal capable of communicating with the first computer;
recording a first conversation log related to conversation content between the first AI agent and the user in a memory of the first computer; and,
when connection to the second computer is disconnected, causing the communication terminal or a second AI agent implemented in the first computer to execute second interaction processing with the user based on the first conversation log.

2. The information processing method according to claim 1, further comprising, in execution of the second interaction processing based on the first conversation log,
identifying, after detecting disconnection of the connection to the second computer, one or more tasks requested to the first AI agent before the disconnection based on the first conversation log,
selecting, as the second AI agent, one capable of executing the one or more tasks from among the communication terminal capable of communicating with the first computer via P2P and one or more second AI agents implemented in the first computer,
inputting, to the second AI agent, task status information including content and progress status of the one or more tasks, and
causing the second AI agent to execute the second interaction processing related to the one or more tasks based on the task status information.

3. The information processing method according to claim 2, wherein
the second AI agent is implemented on the communication terminal capable of communicating with the first computer via P2P, and
the method further comprises transmitting the task status information to the communication terminal when the connection to the second computer is disconnected.

4. The information processing method according to claim 1, further comprising, before the first interaction processing by the first AI agent,
acquiring, from the second computer, agent attribute information for representing a character of the first AI agent,
setting at least one of a GUI or a VUI in the first computer, the GUI and the VUI each representing a character of the first AI agent based on the agent attribute information, and
interfacing the first interaction processing by the first AI agent using at least one of the GUI and the VUI.

5. The information processing method according to claim 4, wherein control of at least one of the GUI or the VUI and recording of the first conversation log are executed by an application installed in the first computer.

6. The information processing method according to claim 4, wherein
the GUI is displayed on a display provided in the vehicle,
the GUI includes a first object and a second object, the first object representing a character of the first AI agent, the second object including letter information directed to the user, and
the first object is displayed at a position farther from the user than the second object in a display region of the display.

7. The information processing method according to claim 6, wherein the letter information includes information about at least one incomplete task that has been requested by the first AI agent and has not yet been completed.

8. The information processing method according to claim 7, further comprising keeping display of the incomplete task after the second interaction processing by the second AI agent is started.

9. The information processing method according to claim 1, further comprising
recording a second conversation log related to content of the second interaction processing in the memory in the first computer while the second AI agent is executing the second interaction processing,
transmitting task status information generated based on the second conversation log to the second computer when connection to the second computer is restored, and
interfacing third interaction processing with the user by the first AI agent by using the microphone and the speaker provided in the vehicle while being connected to the second computer.

10. The information processing method according to claim 9, further comprising, in execution of the third interaction processing based on the second conversation log,
identifying, based on the second conversation log after detecting restoration of the connection to the second computer, one or more tasks requested by the first AI agent before the disconnection or newly requested by the second AI agent in a period of time during which the connection is disconnected,
generating the task status information including content and progress status of the one or more tasks, and
transmitting the task status information to the first computer and causing the first AI agent to execute the third interaction processing related to the one or more tasks based on the task status information.

11. The information processing method according to claim 10, wherein
the second conversation log is managed on the memory and divided into one or more segments corresponding to the one or more tasks, and
the task status information includes a summary sentence obtained by summarizing a segment corresponding to a task to be handed over to the first AI agent in the second conversation log.

12. The information processing method according to claim 9, further comprising, before the third interaction processing by the first AI agent,
acquiring agent attribute information for representing a character of the first AI agent from the second computer,
setting at least one of a GUI or a VUI in the first computer, the GUI and the VUI each representing a character of the first AI agent based on the agent attribute information, and
interfacing the third interaction processing by the first AI agent by using at least one of the GUI or the VUI.

13. The information processing method according to claim 12, wherein recording of the second conversation log and control of at least one of the GUI or the VUI are executed by an application installed in the first computer.

14. A computer provided in a vehicle, the computer comprising:
a processor; and
a memory in which a computer program is stored, the computer program causing the processor to execute the information processing method according to claim 1 as the first computer.

15. An information processing method executed by a second computer on which a first AI agent used by a user is implemented in a human-agent interaction system capable of interacting with the user, the second computer being capable of communicating with a first computer provided in a vehicle, the method comprising:
executing first interaction processing with the user by the first AI agent by using a microphone and a speaker provided in the vehicle, the first interaction processing being executed while being connected to the first computer via a communication device provided in the vehicle or via a communication terminal of the user;
recording a first conversation log related to conversation content between the first AI agent and the user in a memory of the second computer;
identifying one or more tasks requested by the first AI agent based on the first conversation log; and
transmitting task status information including content and progress status of the one or more tasks to the first computer, and causing a second AI agent available to the first computer to execute second interaction processing related to the one or more tasks based on the task status information.

16. The information processing method according to claim 15, wherein the transmitting the task status information is executed in response to determining by the first AI agent that the one or more tasks cannot be processed or should not be processed.

17. The information processing method according to claim 15, wherein the transmitting of the task status information is executed in a case where a use frequency or a use fee of the first AI agent exceeds a predetermined setting value.

18. The information processing method according to claim 15, wherein the transmitting the task status information is executed in response to determining that there is another AI agent more suitable than the first AI agent based on the content of the one or more tasks.

19. The information processing method according to claim 15, wherein
the executing the first interaction processing by the first AI agent is performed by connecting to the second computer on which the first AI agent is implemented via the communication terminal,
the transmitting the task status information is executed in a case where a remaining battery level of the communication terminal falls below a predetermined value, and
the second AI agent is an AI agent installed in the first computer.

20. An information processing method executed by a computer on which an AI agent capable of interacting with a user is implemented, the method comprising:
executing an interaction processing with the user by the AI agent by using a microphone and a speaker provided in the computer or another computer communicable with the computer;
storing, in a memory of the computer, a history of use of the AI agent as a plurality of use logs divided for each date, for each content, or for each date and content;
evaluating a future use value of each of the use logs in a case where a data size of the plurality of use logs exceeds a predetermined value; and
compressing, summarizing, or deleting each of the use logs in accordance with the future use value.
